(19) United States
(12) Patent Application Publication
(10) Pub. No.: US 2010/0181010 A1
(43) Pub. Date: Jul. 22, 2010

(54) METHOD FOR PRODUCING CONSTRUCTION ELEMENTS OF FIBRE-REINFORCED PLASTIC MATERIALS

(75) Inventor: Christian Weimer, Munchen (DE)

Correspondence Address: YOUNG & THOMPSON, 209 Madison Street, Suite 500, Alexandria, VA, 22314, US

(73) Assignee: EUROCOPTER DEUTSCHLAND GMBH, Donauworth (DE)

(21) Appl. No.: 12/602,107

(22) PCT Filed: May 29, 2008
(86) PCT No.: PCT/DE2008/000890

§ 371 Date: Jan. 25, 2010

(30) Foreign Application Priority Data
May 31, 2007 (DE) 10 2007 025 556.1

(51) Int. Cl. B29C 70/06

(52) U.S. Cl. 156/148; 156/166

(57) ABSTRACT

A method for the production of a textile semifinished product consisting of a fibre nonwoven fabric for use as a preform for the production of components composed of fibre-reinforced plastic, in which the fibres are converted by laying/assembling/draping into a fibre nonwoven fabric in the shape of a band corresponding to the power absorptions of the respective component to be generated, being provided with required UD fibre portions and/or thermoplastic fibres and furthermore the fibre architecture of the band is permanently fixed by pre-defined seams.

### FIELD OF THE INVENTION

The invention relates to a method for producing components of fibre-reinforce plastics as they can be used in, for example, the control elements of rotor blades or for the rotor blade itself, of a helicopter.

### BACKGROUND OF THE INVENTION

It is known to wind or braid the fabric-layer forming fibres, provided with or without binder, on a core corresponding to the configuration of the component to be generated and to solidify it in an injection mould comprising the core by means of resin injections and finally to harden it therein. The fabric or braided layers are held on the core by means of friction or preliminary tensioning until transferred into the injection mould. The possibilities of this occurring are limited since differentiations must be made with regard to possible fibre orientation.

As the record has shown, difficulties arise in simultaneously draping and fusing a fibre nonwoven fabric on a core in order to generate such a component known as a preform, in particular if it has a multi-layer construction as well as additional single fibres, which are directed unidirectionally and consist of UD layers. As a rule, the construction of the fibre nonwoven fabric and the direction of the individual fibres suffer considerably to the extent that the completed preform does not have the required solidity properties subsequent to removal from the injection mould. A draping, that is to say converting the fibre nonwoven fabric into a three-dimensional shape, is nearly impossible with such a method. This is particularly the case in the production of rotationally symmetrical, complex components composed of fibre-reinforced plastics such as, for example, in the production of yokes for the rotor blades of a helicopter. These were previously produced from two separate shells that were connected into one component for the hardening process. Such a production method demands that fibre nonwoven fabrics necessarily be separated upon their production in order to be received by the engaging torsional force of the completed component, which separation is likewise disadvantageous for subsequent power absorption.

Here the invention addresses the problem of introducing a new method of producing a fibre-reinforced structure, which method does not entail the above-described disadvantages.

### OBJECT AND SUMMARY OF THE INVENTION

This problem is solved according to the invention by the features of claim 1.

Further features of the invention are obtained from the dependent claims.

The method according to the invention enables first that the fibre nonwoven fabric required for the production of the preform is available as an exactly prepared, textile semifinished product that maintains its given fibre structure by means of the exactly pre-determined seams and therefore can be wound on the core of an injection tool, or of an auxiliary material, even in a draped state, without losing the prepared, closed fibre architecture. In this manner, complex, rotationally symmetrical components can be produced that have full utilisation of the fibre properties of the fibre nonwoven fabric and with precise adjustment of the layer thicknesses necessary for use. Furthermore, in the winding of the textile semifinished product on the core of the injection mould, additional components, which are necessary for the finished product, can be integrated in the preform more easily than before. The hardened, completed components exhibit in their use a homogenous load distribution.

The production method can also be automated by the use of sewing units without the prepared fibre architecture of the textile semifinished product being changed. With the admixture of thermoplastic fibres, the textile semifinished product can be easily fused onto the respective core of the injection tool. A partial heating of the thermoplastic fibres, for example by means of a fusing roller, is sufficient without the entire textile semifinished product necessarily being thereby heated.

### BRIEF DESCRIPTION OF THE DRAWINGS

The invention is described below using the production aids for carrying out the method according to the invention that is more or less schematically shown in the drawings.

It is shown in

FIG. 1 a section of a textile semifinished product, which was created by laying and assembling fibres, in the shape of a band for the generation of a preform according to the invention;

FIG. 2 the side view of an inner core as part of a preform winding tool with the fibre nonwoven fabric configured as a previously assembled band, according to FIG. 1, in a two-dimensional state;

FIG. 3 the side view of the inner core according to FIG. 2 with the previously assembled band according to FIG. 1 in the shaped, three-dimensional state;

FIG. 4 the inner core according to FIG. 3 with fused band, and

FIG. 5 the inner core according to FIG. 4 in the injection tool configured as separable.

### MORE DETAILED DESCRIPTION

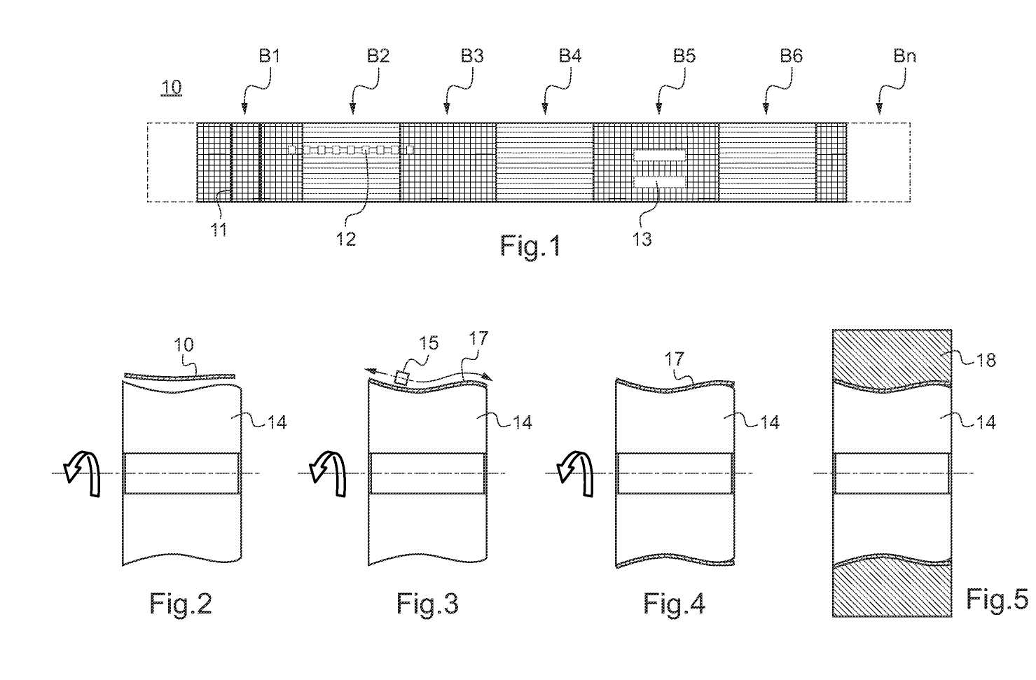

A band 10 shown in sections in FIG. 1 consisting of a conventional fibre nonwoven fabric produced by laying and assembling processes has sectionally arranged regions B1 to Bn that in their formation are configured to correspond with one another to some extent while also being partially different from one another. The region B1, which exhibits a high degree of drapability, has thermoplastic fibres 11 for fusing the band onto the core of an injection tool by means of pressure rollers and fusing rollers. The region B2 is provided with unidirectionally directed fibres (UD fibres) 12 that are arranged in the neutral phase or in the draping phase. The region B4 corresponds to the region B2, but is without UD-fibre portions. The region B5 has slits 13 for integrating the components for the transmission of force into the preform.

The region B6 corresponds to the region B4 and so forth.

The fibre nonwoven fabric generated in this manner, the fibres and draping of which correspond exactly to the pre-determined properties of the preform to be generated, is fixed permanently in its position once it has taken said position by seams generated by means of a two-thread lock stitch sewing unit in such a manner that an easily managed textile semifinished product results.

The band representing a textile semifinished product can be generated continuously, intermediately stored or further processed immediately after having arrived from the sewing unit. This occurs according to FIGS. 2 to 5 in the manner that the band 10 undergoes final contouring, that is to say is cut to the required length, is wound on the inner core 14 as a two-dimensional layer, and, according to FIG. 3, is converted by moveable pressure rollers and fusing rollers 15 of the winding head, which is not shown, into a three-dimensional preform 17 that corresponds to the contour of the inner core 14 and that furthermore corresponds to the contour of the component to be generated. By means of thermoplastic fibres in the band 10, said band is fused on the core 14. The core 14 provided with the fused band, as FIG. 5 shows, is subsequently placed in the separable injection tool 18 in which the preform 17 is converted into its final shape by resin injection, which is followed by hardening.

If elements that transmit force are to be introduced into the preform, slits 13 for their arrangement are to be inserted into the band 10 in the pre-determined direction subsequent to the yet-to-be-undertaken decontouring of said band 10; cf. FIG. 1.

### REFERENCE NUMBER LIST

10 Band
11 Thermoplastic fibres
12 UD fibre portions
13 Slit
14 Inner core, core
15 Fusing roll
16
17 Preform
18 Injection tool

1. A method for producing components of fibre-reinforced plastics, such as control elements for the rotor blades as well as rotor blades of a helicopter, in which the fibres are positioned as fabric layers on a core and are hardened into a component by means of resin injection, having the following method steps:
the fibres are converted, by means of laying/assembling/draping, into a fibre nonwoven fabric in the shape of a band corresponding to the contours of the respective component to be generated,
required UD fibres are precisely positioned on the band and applied in the circumferential direction of the respective component to be generated,
the fibres of the fibre nonwoven fabric created in such a manner are fixed in their location by means of pre-defined seams and are thereby converted into a textile semifinished product that can be stored,
the band undergoes final contouring corresponding to the dimensions of the component to be produced subsequent to which said band is wound on a core of an injection tool and is solidified into the final preform by means of resin injection.

2. The method as specified in claim 1, characterised in that thermoplastic fibres can be added to the fibre nonwoven fabric in the shape of a band for the purposes of mechanically fusing the band on the core of the injection tool.

3. The method as specified in claim 1, characterised in that the thermoplastic fibres are added in the region of the high degree of drapability of the fibre nonwoven fabric exhibiting the shape of a band.

4. The method as specified in claim 1, characterised in that the required UD fibre portions are applied and fused in the neutral phase of the fibre nonwoven fabric exhibiting the shape of a band.

5. The method as specified in claim 4, characterised in that the required UD fibre portions are applied outside the regions having a high degree of drapability of the fibre nonwoven fabric exhibiting the shape of a band.

6. The method as specified in claim 1, characterised in that subsequent to the final contouring of the fibre nonwoven fabric exhibiting the shape of a band, it is provided with slits for integrating the components for the transmission of force into the preform.

7. The method as specified in claim 2, characterised in that upon mechanical fusing, the thermoplastic fibres of the fibre nonwoven fabric exhibiting the shape of a band are heated by means of a fusing roll.

8. The method as specified in claim 1, characterised in that a sewing unit generating a two-thread lock stitch is used to produce seams fixing the fibre architecture of the band.
